(19) United States
(12) Patent Application Publication
(10) Pub. No.: US 2012/0086610 A1
(43) Pub. Date: Apr. 12, 2012

(54) ANTENNA AND PORTABLE WIRELESS TERMINAL EQUIPPED THEREWITH

(75) Inventors: Tomoaki Nishikido, Ishikawa (JP); Yoshio Koyanagi, Kanagawa (JP); Hiroyuki Uno, Ishikawa (JP)

(73) Assignee: PANASONIC CORPORATION, Osaka (JP)

(21) Appl. No.: 13/375,290

(22) PCT Filed: Feb. 22, 2010
(86) PCT No.: PCT/JP2010/001159

§ 371 Date: Nov. 30, 2011

(30) Foreign Application Priority Data
Jun. 18, 2009 (JP) 2009-144904

(51) Int. Cl. H01Q 1/24

(52) U.S. Cl. 343/702

(57) ABSTRACT

There is provided a flip portable radio that can be reduced in thickness and size; that requires a broadband characteristic for an antenna; and that can exhibit high communication performance according to various states of usage.

A flip portable radio has a matching circuit that feeds power to a metal rotary shaft 14 which makes an upper enclosure 12 and a lower enclosure 11turnable and which matches impedance to 50 ohms at two operation frequencies or more. A diameter L1 of a cross section of a metal rotary shaft 14 is set to about 1/20 or more of a wavelength λ2. An effective length of a metal rotary shaft 14 is set to about λc/4 of a wavelength λc of a center frequency of a high frequency band. The metal rotary shaft 14 is placed at a given interval away from a first circuit board 11A and a second circuit board 12A.

### TECHNICAL FIELD

The present invention relates to an antenna that operates on a wide band and exhibits high call performance and that involves occurrence of a small change in emission characteristic which will arise during opening and closing of a portable wireless terminal, as well as to a portable flip wireless terminal equipped with the antenna.

### BACKGROUND ART

With a dramatic increase in the number of cellular phones, a shortage of frequencies used in communication has come to an issue. A communication cellular antenna compatible with a tri-band system (the 800 MHz band, the 1.7 GHz band, and the 2 GHz band) is now required. In the meantime, under circumstances where cellular phones growingly become thinner, if a small cellular phone is equipped with all of a plurality of antennas compatible with frequency bands of a tri-band system, the cellular phone will become larger, which will in turn deteriorate a design feature of the cellular phone. For this reason, a high gain multiband broadband antenna compatible with a plurality of frequency bands without deterioration of a design feature has become necessary as an antenna to be incorporated in a cellular phone. Moreover, a structure of a recent cellular phone is complicate and also changes according to a utilization form. For instance, in addition to performing related art reclosable opening action, the cellular phone performs landscape-oriented opening action, to thus open horizontally. Therefore, a stable high emission characteristic is required in all states without involvement of deterioration of an antenna characteristic.

A known specific example of such a broadband flip cellular phone is described in; for instance, Patent Document 1 and Patent Document 3. In antenna configurations of these examples, a feed element having a predetermined element length is connected to a metal hinge, thereby letting the metal hinge operate as a broadband antenna.

Moreover, for instance, in an antenna configuration described in connection with Patent Document 2, power is fed to a metal hinge, and a passive element is brought in close proximity to the metal hinge, thereby letting the metal hinge operate as a broadband antenna.

Further, a specific example design-oriented antenna configuration includes; for instance, the antenna configuration described in connection with Patent Document 3, wherein power is fed to the metal hinge, thereby letting the metal hinge operate as an antenna that resonates at a single frequency band. Thus, an antenna footprint can be reduced without provision of a new antenna element.

### RELATED ART DOCUMENTS

### Patent Documents

Patent Document 1: JP-A-2009-94859

Patent Document 2: International Publication No. WO 2007/032330

Patent Document 3: JP-A-2007-88629

### DISCLOSURE OF THE INVENTION

### Problem that the Invention is to Solve

However, in the antenna configuration described in connection with Patent Document 1, another element that is connected to the metal hinge and resonated at a desired frequency band must be placed in proximity to the metal hinge in order to assure a broadband characteristic. This affords a complicate surrounding structure to the hinge, thereby posing difficulty in miniaturizing the antenna. There has been a growing trend in recent years to place importance on design as a reason for purchasing a cellular phone, or the like. For this reason, the above antenna configuration may deteriorate the design of a cellular phone, and structural complexity conceivably adds to cost.

Further, the antenna configuration described in connection with Patent Document 2 requires a passive element to be placed in an enclosure which holds a metal hinge in order to assure a broadband characteristic. The structure of the antenna is very complicate, and the hinge must be made large. This may impair the design of the cellular phone, and the complicate structure also conceivably adds to cost. Moreover, in a closed state, requirements for the metal hinge and a circuit board on a display side with respect to the height of a portable terminal are uncertain. Accordingly, a broadband characteristic of the terminal may be deteriorated.

In the antenna configuration described in connection with Patent Document 3, power is fed to the metal hinge, and only a single frequency is taken as a resonance characteristic because of importance imposed on a design. Since a positional relationship between the metal hinge and circuit boards in upper and lower enclosures is indefinite. Therefore, difficulty is encountered in accomplishing a broadband characteristic in a closed state.

The present invention has been conceived in light of the circumstance and aims at providing a portable flip radio that provides a broadband characteristic of an antenna, that allows a reduction in thickness and size of enclosures, and that enables exhibition of high communication performance according to various states of usage.

### Means for Solving the Problem

A portable radio of the present invention includes: a first enclosure equipped with a first circuit board; a second enclosure equipped with a second circuit board; a first metal rotary shaft that joins the first enclosure to the second enclosure in a turnable manner and that exhibits electrical conductivity; a feed section connected to the first metal rotary shaft; a matching circuit that is placed on the first circuit board and connected to the feed section; and a radio circuit that is connected to the matching circuit and that is placed on the first circuit board, wherein the first metal rotary shaft is placed at a given interval away from a ground pattern on the first circuit board and electrically connected to the feed section; the first metal rotary shaft operates as an antenna at a first frequency band and a second frequency band that is higher than the first frequency band; a diameter of a cross section of the first metal rotary shaft is set to about 1/20 of a wavelength corresponding to the second frequency band; and the first metal rotary shaft does not oppose a ground pattern on the second circuit board along a thicknesswise direction of the enclosures when the first and second enclosures are closed.

The portable radio can also be configured such that, when the first enclosure and the second enclosure are closed, an axial center of the first metal rotary shaft is situated on the first enclosure. By means of the configuration, a broadband, high-gain antenna is implemented. Further, when enclosures are opened and closed, little change occurs in characteristic, and the metal rotary shaft is used also as an antenna. Therefore, the cellular phone can be miniaturized. Specifically, there can be provided a portable wireless terminal that can exhibit high communication performance and a superior design.

Moreover, there portable radio can also be configured such that a third circuit board is placed in the second enclosure in proximity to the first metal rotary shaft; that the second circuit board and the third circuit board are connected together by way of a reactance element; and that a ground pattern on the third circuit board opposes the first metal rotary shaft in a thicknesswise direction of the enclosures when the first enclosure and the second enclosure are closed. By means of the configuration, a portable wireless terminal can be miniaturized by means of an increase in component footprint while high communication performance is assured.

It is also preferable that the portable wireless terminal be equipped with a second metal rotary shaft which exhibits electrical conductivity and which joins the first enclosure to the second enclosure in a turnable manner along an axial direction orthogonal to an axial direction of the first metal rotary shaft, wherein the first metal rotary shaft and the second metal rotary shaft are at a given interval away from each other. By mean of the configuration, even a portable wireless terminal that changes according to various usage patterns can also assure superior communication performance.

It is preferable that the portable wireless terminal be equipped with a short-circuit element which is away at a given interval from the first metal rotary shaft and the first circuit board and which is laid substantially in parallel with the first metal rotary shaft, wherein one end of the short-circuit element is short-circuited to the ground pattern on the first circuit board located in proximity to the feed section. By means of the configuration, a greater broadband characteristic can be assured, and superior communication performance can be assured.

The portable wireless terminal can also be configured such that one end of the short-circuit element is short-circuited to the ground pattern on the first circuit board located in proximity to the feed section by way of a reactance element. Since the configuration enables shortening of the short-circuit element, the portable wireless terminal can be miniaturized.

The portable wireless terminal can also be configured such that the short-circuit element is at a given interval away from a surface of the first enclosure that opposes another surface thereof which comes into close proximity to a surface of the second enclosure when the first enclosure and the second enclosure are closed. By means of the configuration, even when the portable wireless terminal is put on the metal desk, superior communication performance can be assured.

The portable wireless terminal can also be configured so as to further include a metal shield that blocks unwanted emission of the radio circuit, wherein a first short-circuit point of the metal shield is short-circuited to the ground pattern on the first circuit board located in proximity to the feed section; and wherein a second short-circuit point is placed away from the first short-circuit point at an interval that is about one-half a wavelength corresponding to a high frequency band and is short-circuited to the ground pattern on the first circuit board. By means of the configuration, another element to be employed as a short-circuit element becomes obviated. Therefore, size and cost of the portable wireless terminal can be reduced.

### Advantage of the Invention

The portable wireless terminal of the present invention exhibits a broadband characteristic, allows a reduction in thickness and size of enclosures, and can exhibit high communication performance according to various states of usage.

### BRIEF DESCRIPTION OF THE DRAWINGS

FIG. 1 (a) is a front view of a flip cellular phone 10 of a first embodiment of the present invention in an open state, (b) is a right side view of the flip cellular phone 10 of the first embodiment of the present invention in an open state, and (c) is a right side view of the flip cellular phone 10 of the first embodiment of the present invention in a closed state.

FIG. 2 is an oblique perspective view showing a configuration of a metal rotary shaft 14 of the first embodiment of the present invention.

FIG. 3 (a) is a right side view of the flip cellular phone 10 of the first embodiment of the present invention in a closed state, and (b) is a view showing a VSWR characteristic exhibited with respect to a change in a diameter L1 of a cross sectional area of the metal rotary shaft 14 of the first embodiment of the present invention.

FIG. 4 (a) is a right side view of the flip cellular phone 10 of the first embodiment of the present invention in a closed state, and (b) is a view showing emission efficiency exhibited at spacing D2 between the metal rotary shaft 14 and a second circuit board 12A when the flip cellular phone 10 of the first embodiment of the present invention is closed.

FIG. 5 (a) is a front view of a flip cellular phone 20 of a second embodiment of the present invention in an open state, and (b) is a right side view of the flip cellular phone 20 of the second embodiment of the present invention in a closed state.

FIG. 6 (a) is a front view of a flip cellular phone 30 of a third embodiment of the present invention opened in a portrait orientation, and (b) is a left side view of the flip cellular phone 30 of the third embodiment of the present invention opened in the portrait orientation.

FIG. 7 (a) is a front view of the flip cellular phone 30 of the third embodiment of the present invention opened in a landscape orientation, and (b) is a left side view of the flip cellular phone 30 of the third embodiment of the present invention opened in the landscape orientation.

FIG. 8 (a) is a front view of a flip cellular phone 40 of a fourth embodiment of the present invention in an open state, (b) is a right side view of the flip cellular phone 40 of the fourth embodiment of the present invention in an open state, and (c) is a right side view of the flip cellular phone 40 of the fourth embodiment of the present invention in a closed state.

FIG. 9 (a) is a right side view of the flip cellular phone 40 of the fourth embodiment of the present invention in a closed state, and (b) is a view showing a VSWR characteristic exhibited according to whether or not a short-circuit element is present in the flip cellular phone 40 of the fourth embodiment of the present invention in a closed state.

FIG. 10 is a front view of a flip cellular phone 50 of a fifth embodiment of the present invention in an open state.

FIG. 11 is a side view of a flip cellular phone 60 of a sixth embodiment of the present invention in a closed state.

FIG. 12 is a side view of the flip cellular phone 60 of the sixth embodiment of the present invention achieved when placed on a metal desk.

FIG. 13 is a front view of a flip cellular phone 70 of a seventh embodiment of the present invention in an open state.

### EMBODIMENTS FOR IMPLEMENTING THE INVENTION

Preferable embodiments of the present invention will be hereunder described in detail by reference to the drawings.

### First Embodiment

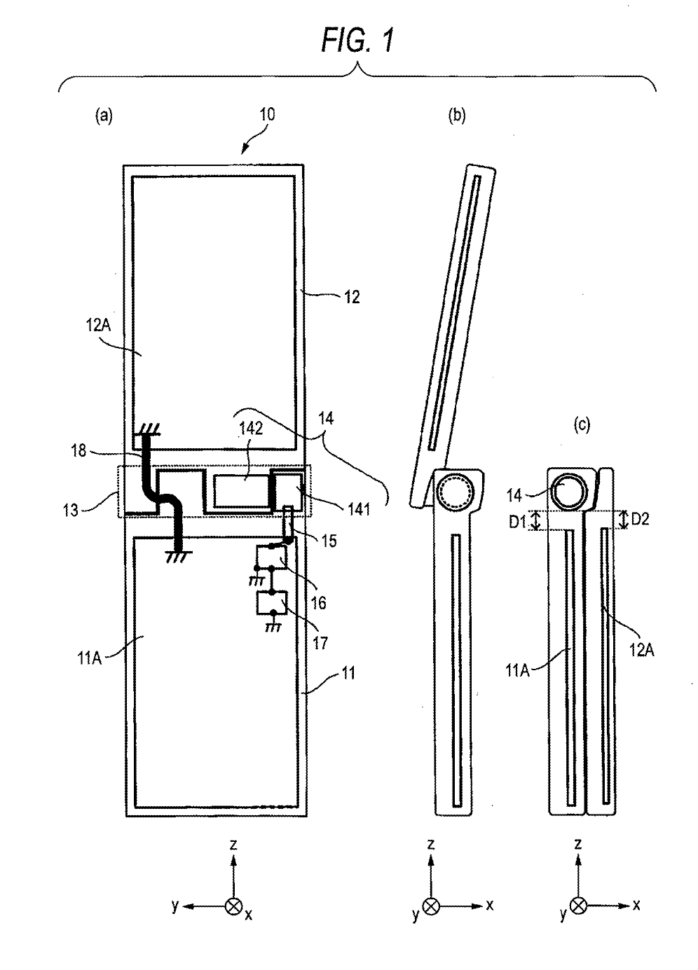

FIGS. 1(a) to FIG. 1(c) show a flip cellular phone 10 of a first embodiment of a portable radio of the present invention. FIG. 1(a) is a front view of the flip cellular phone 10 of the first embodiment of the present invention in an open state; FIG. 1(b) is a right side view of the flip cellular phone 10 of the first embodiment of the present invention in an open state; and FIG. 1(c) is a right side view of the flip cellular phone 10 of the first embodiment of the present invention in a closed state.

The flip cellular phone 10 shown in FIGS. 1(a) to 1(c) includes a lower enclosure 11 making up a first enclosure, an upper enclosure 12 making up a second enclosure, a conductive metallic rotary shaft 14 disposed in a hinge 13 that joins the upper enclosure 12 to the lower enclosure 11 in a turnable fashion, a feed spring 14, an impedance matching circuit 16, a radio circuit 17, and a signal line 18.

The upper enclosure 12 has an unillustrated display section and a second circuit board (an upper circuit board) 12. The lower enclosure 11 has an unillustrated operation section, a first circuit board (a lower circuit board) 11A, the previously-described impedance matching circuit 16, and the radio circuit 17.

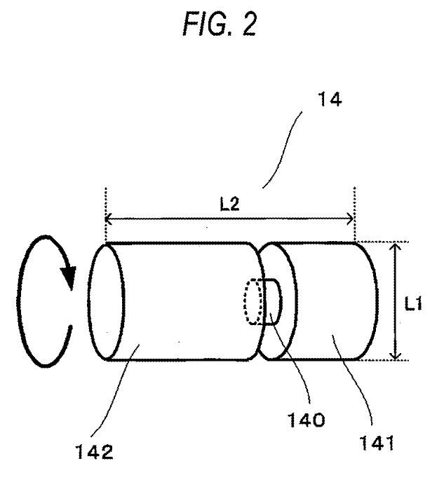

The metal rotary shaft 14 joins the upper enclosure 12 to the lower enclosure 11 in a turnable fashion. As shown in FIG. 2, the metal rotary shaft 14 includes a stationary section 141 of the metal rotary shaft fastened to the lower enclosure 11, a rotary section 142 of the metal rotary shaft that is attached, in a turnable fashion, to the stationary section 141 of the metal rotary shaft and that is fastened to the upper enclosure 12, and a joint 140 that electrically connects the stationary section 141 of the metal rotary shaft to the rotary section 142 of the metal rotary shaft and supports the joint section 140 in a turnable fashion.

In a closed state of the metal rotary shaft 14, an axial center of the metal rotary shaft 14 is placed on a side of the lower enclosure 11 with respect to a thicknesswise direction of the closed portable flip wireless terminal 10.

The metal rotary shaft 14 is electrically connected to the impedance matching circuit 16 and the radio circuit 17 by way of a feed spring 15. The feed spring 15 serves as a feed section and is electrically connected to a position that is at distance of a length of about one-fifth of the metal rotary shaft from one end of the metal rotary shaft 14; for instance, an end of the metal rotary shaft. The impedance matching circuit 16 connected to the feed spring 15 is placed at one end of the first circuit board 11A that is closer to the metal rotary shaft 14.

The impedance matching circuit 16 matches impedance of the metal rotary shaft 14 to 50 ohms at a first operation frequency band f1 and a second operation frequency band f2 that is away from the first operation frequency band f1 at a distance which is nearly double a distance from the first operation frequency band f1.

The metal rotary shaft 14 operates as an antenna at two operation frequency bands or more. For this reason, it is desirable to make the metal rotary shaft 14 such that a diameter L1 of a cross sectional area of the metal rotary shaft 14 comes to a wavelength which is about 1/20 or more of a wavelength λ2 corresponding to the second operating frequency band f2 and that a length L2 of the metal rotary shaft 14 comes to about a quarter (λ.c/4) wavelength which is an effective length at which resonance occurs, because of the cross sectional area and length L2 of the metal rotary shaft 14, at a center frequency fc (a wavelength is λc) of the second operation frequency band f2.

Spacing D1 between the metal rotary shaft 14 and the first circuit board 11A is desirably about 1/25 or more of the wavelength λ2, and spacing D2 between the metal rotary shaft 14 and the second circuit board 12A is desirably about 1/35 or more of the wavelength λ2. When the flip cellular phone 10 is in a closed state, the spacing D2 corresponds to longitudinal spacing between the metal rotary shaft 14 and the second circuit board 12A and does not mean a direct distance.

In the present embodiment, the metal rotary shaft 14 having a predetermined cross sectional area or more is configured as an antenna that operates at two operation frequency bands or more.

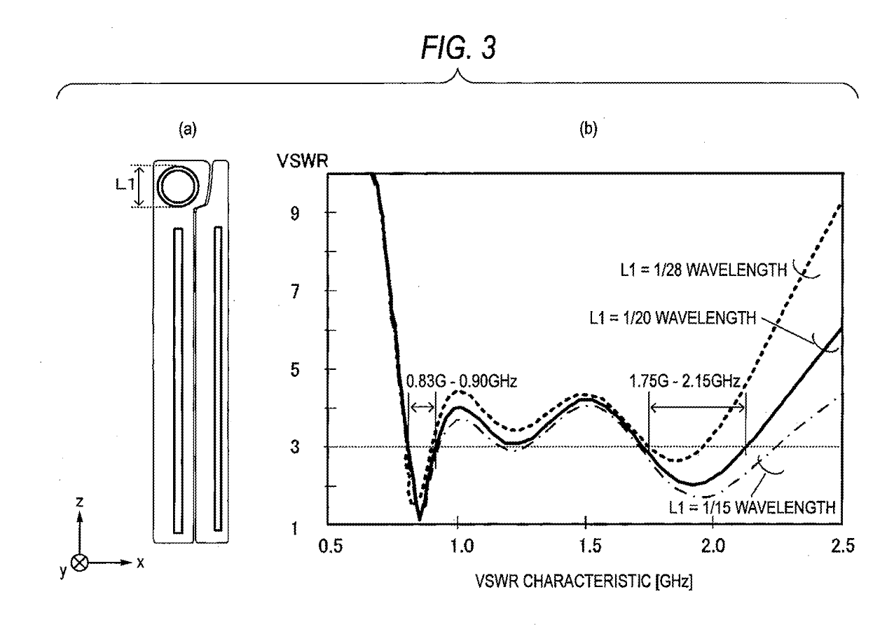

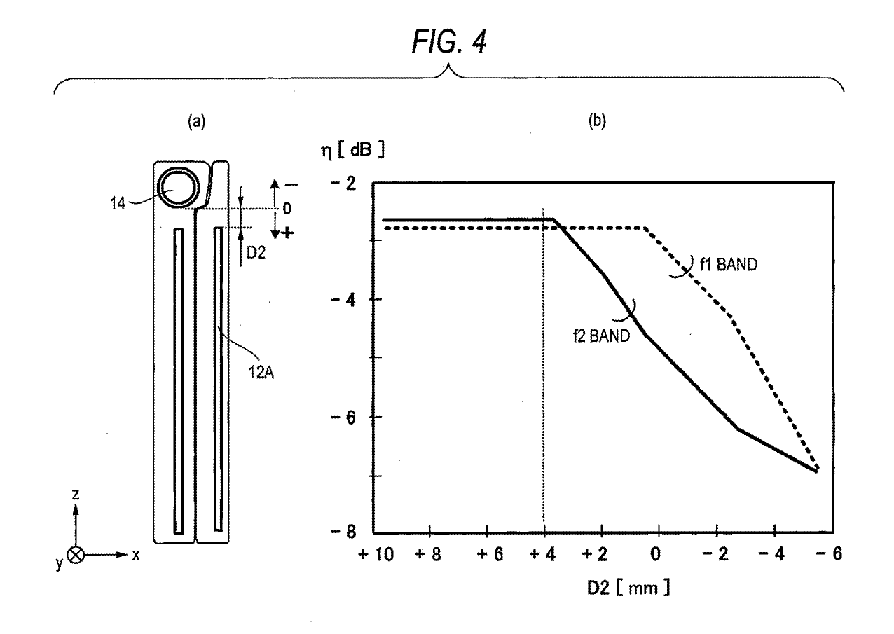

Operation of the flip cellular phone 10 of the first embodiment of the present invention is now described by reference to FIG. 3(a), FIG. 3(b), FIG. 4(a), and FIG. 4(b).

### (1) About a Cross Sectional Area of the Metal Rotary Shaft 14:

FIG. 3(a) is a right side view of the flip cellular phone 10 of the first embodiment of the present invention in a closed state, and FIG. 3(b) is a view showing a VSWR characteristic exhibited with respect to a change in the diameter L1 of the cross sectional area of the metal rotary shaft 14 of the first embodiment of the present invention. In general, VSWR<3 is defined as a bandwidth of an antenna.

For instance, the operation frequency band is herein defined such that the first operation frequency band f1 ranges from 830 MHz band to 900 MHz band and that the second operation frequency band f2 ranges from 1.75 GHz band to 2.15 GHz band. Therefore, it is desirable that VSWR<3 is obtained at the first operation frequency band f1 and the second operation frequency band f2.

FIG. 3(a) and FIG. 3(b) show VSWR characteristics exhibited when the diameter L1 of the cross sectional area of the metal rotary shaft 14 is 1/28 of the wavelength λ2 (designated by a dotted line), when the diameter L1 is 1/20 of the wavelength λ2 (designated by a solid line), and when the diameter L1 is 1/15 of the wavelength λ2 (designated by a dashed-dotted line). In each of the cross sectional areas, the length L2 is adjusted so as to accomplish VSWR<3 at 1.75 GHz band.

FIG. 3(a) and FIG. 3(b) show that a great change occurs in the second operation frequency band f2 at the diameter L1 of the cross sectional area. So long as the diameter L1 of the cross sectional area is a 1/20 wavelength (λ2) or more, VSWR<3 can be satisfied at the operation frequency band. Specifically, the diameter L1 of the cross sectional area must be the 1/20 wavelength (λ2) or more.

### (II) About the Spacing D2 Between the Metal Rotary Shaft 14 and the Second Circuit Board 12A:

FIG. 4(a) is a right side view of the flip cellular phone 10 of the first embodiment of the present invention in a closed state, and FIG. 4(b) is a view showing an emission efficiency characteristic exhibited in response to a change in the spacing D2 between the metal rotary shaft 14 and the second circuit board 12A when the flip cellular phone 10 of the first embodiment of the present invention is in a state of FIG. 1(c). The spacing D2 represented by a horizontal axis corresponds to longitudinal spacing between the metal rotary shaft 14 and the second circuit board 12A achieved during closing of the cellular phone. When the lower end of the metal rotary shaft 14 coincides with the upper end of the second circuit board 12A in their longitudinal direction, the spacing is taken as 0 mm. Further, when an overlap occurs between the lower end and the upper end, a symbol “−” is given. On the contrary, when the lower end and the upper end depart from each other, a symbol “+” is provided. An emission efficiency characteristic yielded at the first operation frequency band f1 is designated by a dotted line, whilst the emission efficiency characteristic yielded at the second operation frequency band f2 is designated by a solid line.

In FIG. 4(a) and FIG. 4(b), when the spacing D2 comes to 4 mm or less, the emission efficiency exhibited at the second operation frequency band f2 tends to become worse. Therefore, in order to prevent deterioration of emission efficiency, the spacing D2 must be about 1/35 or more of the wavelength λ2.

From the above, the diameter L1 of the cross sectional area of the metal rotary shaft 14 is set to 1/20 of the wavelength λ2, and the spacing D2 between the metal rotary shaft 14 and the second circuit board 12A is set to about 1/35 or more of the wavelength λ2. Thereby, it is possible to assure high communication performance at both the open state and the closed state of the flip cellular phone 10.

Accordingly, in the present embodiment, a broadband antenna can be implemented in nominal space of the hinge 13 by adoption of the following antenna configuration. Specifically, the configuration includes a matching circuit that feeds power to the metal rotary shaft 14 which enables turning action of the upper enclosure 12 and the lower enclosure 11, thereby letting the metal rotary shaft 14 act as an antenna at two operation frequency bands or more. Further, in the antenna configuration, the diameter L1 of the cross sectional area of the metal rotary shaft 14 is set to a wavelength which is about 1/20 of the wavelength λ2 or more, thereby accomplishing an effective length that is a wavelength of about λc/4. The spacing D1 between the metal rotary shaft 14 and the first circuit board 11A is set to a value of about 1/25 or more of the wavelength λ, and the spacing D2 between the metal rotary shaft 14 and the second circuit board 12A is set to a value of about 1/35 or more of the wavelength λ2. Accordingly, the antenna configuration is effective for reducing the thickness and size of the flip cellular phone 10. Since an antenna space in the upper enclosure 12 and the lower enclosure 11 is not required, miniaturization of the cellular phone can be implemented. Further, it is possible to implement a broadband, high-gain portable wireless terminal whose antenna does not protrude out of an enclosure and that has a design-oriented configuration.

### Second Embodiment

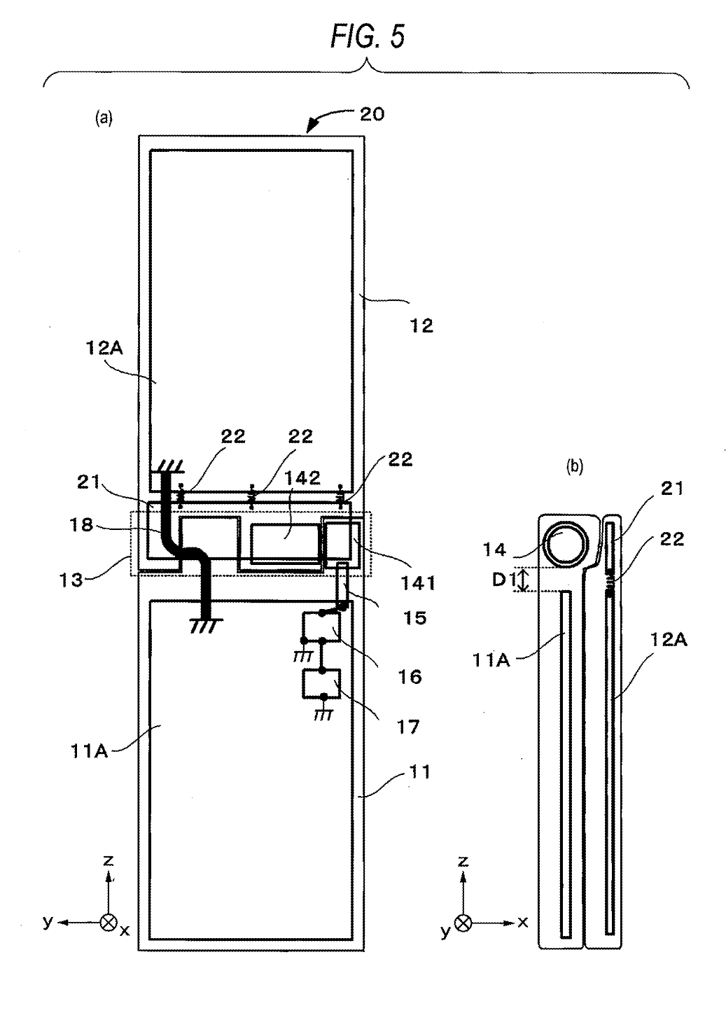

By reference to FIGS. 5(a) and 5(b), a second embodiment of the present invention is now described in detail. In the present embodiment, elements that are identical with their counterparts described in connection with the first embodiment are assigned the same reference numerals, thereby avoiding their repeated explanations.

FIG. 5(a) is a front view of a flip cellular phone 20 of the second embodiment of the present invention in an open state, and FIG. 5(b) is a right side view of the flip cellular phone 20 of the second embodiment of the present invention in a closed state.

A difference between the flip cellular phone 20 shown in FIG. 5(a) and FIG. 5(b) and the flip cellular phone 10 shown in FIG. 1(a) to FIG. 1(c) resides in that a third circuit board 21 is provided in the upper enclosure 12 and that the third circuit board 21 and the second circuit board 12A are connected by way of a reactance element 22.

A ground pattern (not shown) of the third circuit board 21 and a ground pattern (not shown) of the second circuit board 12A are connected by way of the reactance element 22. Further, a signal line (not shown) of the second circuit board 12A and a signal line (not shown) of the third circuit board 21 are connected by way of the reactance element 22.

Operation of the flip cellular phone 20 of the second embodiment of the present invention is now described.

In order to house a component in limited space in the enclosure of the flip cellular phone 20, a component must also be incorporated into space of the upper enclosure 12 to which the metal rotary shaft 14 of the second circuit board 12A comes to close. In such a case, there is a concern that emission efficiency of the antenna might be deteriorated according to a distance of the spacing D2, as shown in FIG. 4(a) and FIG. 4(b) that pertain to the first embodiment.

In the present embodiment, in order to lessen deterioration of emission efficiency when the third circuit board 21 comes close to the metal rotary shaft 14, the ground pattern of the third circuit board 21 and the ground pattern of the second circuit board 12A are connected by way of the reactance element 22; for instance, a circuit in which a filter circuit for the first operation frequency band f1 and a filter circuit for the second operation frequency band f2 are arranged in series. Further, the signal line of the third circuit board 21 and the signal line of the second circuit board 12A are connected by way of the reactance element 22; for instance, a circuit in which the filter circuit for the first operation frequency band f1 and the filter circuit for the second operation frequency band f2 are arranged in series. The filter circuit for the first operation frequency band f1 and the filter circuit for the second operation frequency band f2 may also be an LC-parallel resonance circuit. The filter circuits must be connected in series in order to connect the signal lines together.

As mentioned above, as a result of the reactance element 22 being provided, the influence of the third circuit board 21 is lessened at the first operation frequency band f1 and the second operation frequency band f2, so that deterioration of efficiency can be suppressed low.

Therefore, according to the present embodiment, the third circuit board 21 provided in the upper enclosure 12 and the second circuit board 12A are connected together by way of the reactance element 22. As a result, even when a component is mounted in the space of the upper enclosure 12 (the third circuit board 21) located in proximity to the metal rotary shaft 14, deterioration of emission efficiency can be reduced. A component footprint accordingly increases, which enables miniaturization of the portable wireless terminal.

### Third Embodiment

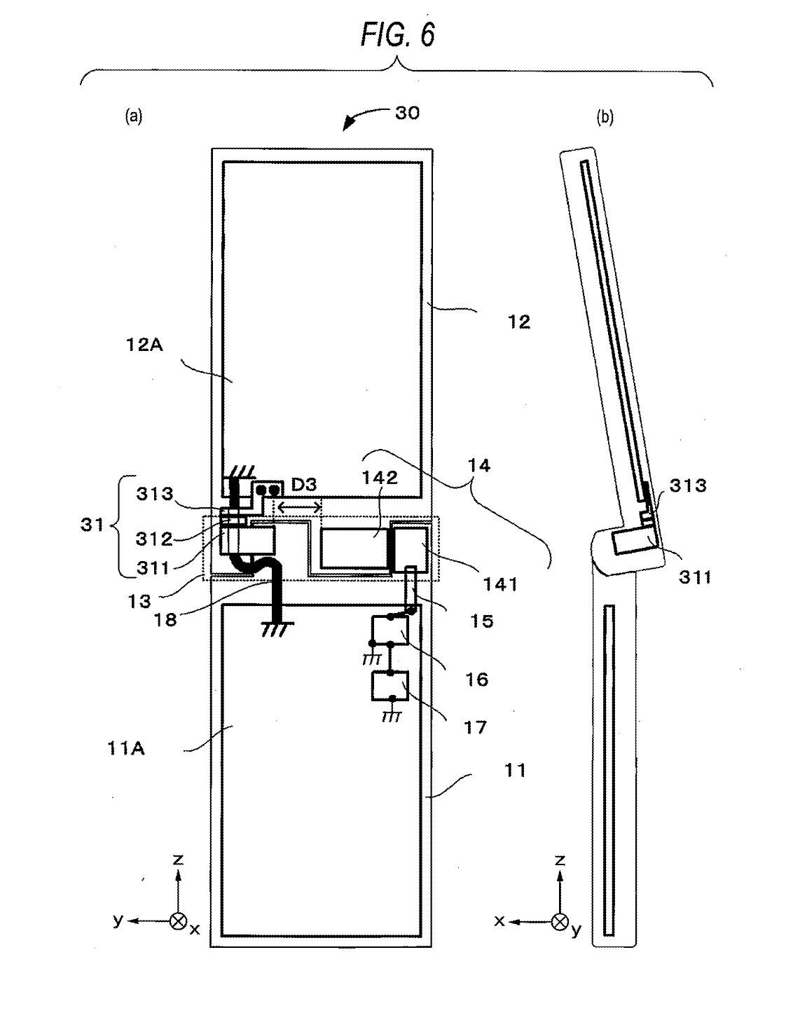

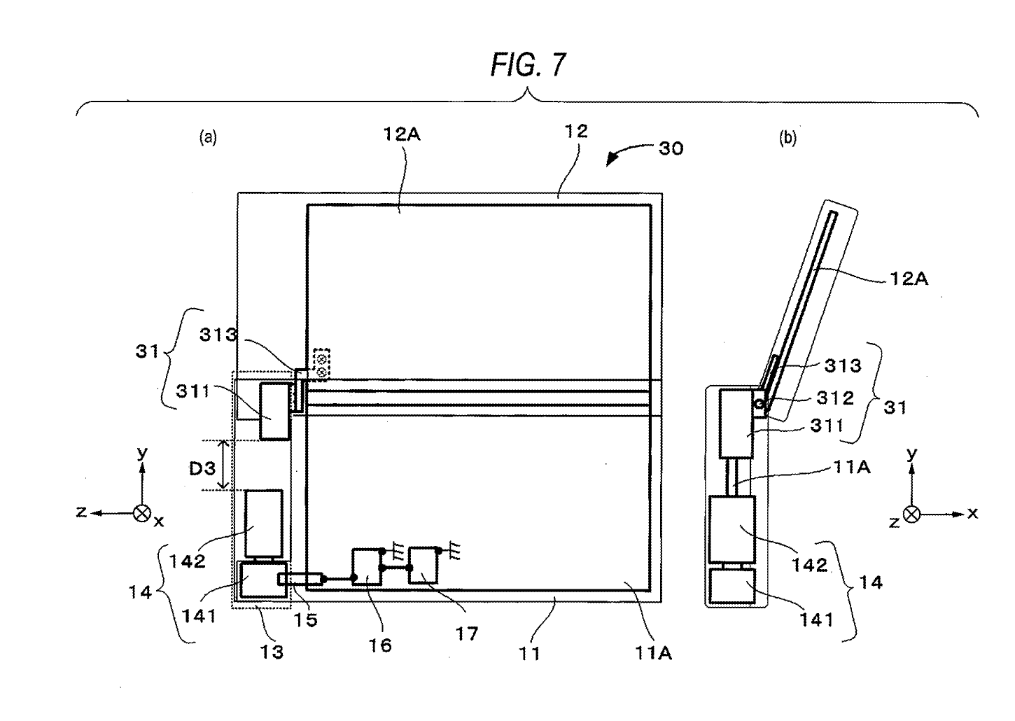

A third embodiment of the present embodiment is now described in detail by reference to FIG. 6(a), FIG. 6(b), FIG. 7(a), and FIG. 7(b). In the present embodiment, elements that are identical with their counterparts described in connection with the first embodiment are assigned the same reference numerals, and their repeated explanations are omitted here for brevity.

FIG. 6(a) is a front view of a flip cellular phone 30 of the third embodiment of the present invention opened in the portrait orientation, and FIG. 6(b) is a left side view of the flip cellular phone 30 of the third embodiment of the present invention opened in the portrait orientation. FIG. 7(a) is a front view of the flip cellular phone 30 of the third embodiment of the present invention opened in the landscape orientation, and FIG. 7(b) is a left side view of the flip cellular phone 30 of the third embodiment of the present invention opened in the landscape orientation.

Unlike the first and second embodiments, the flip cellular phone 30 of the embodiment makes up a biaxial flip cellular phone in which the upper enclosure 12 and the lower enclosure 11 can open and close in a right-left direction (the landscape direction) shown in FIGS. 7(a) and 7(b) as well as in an up-down direction (the portrait direction) shown in FIG. 6(a) and FIG. 6(b).

Consequently, in addition to including the upper enclosure 12, the lower enclosure 11, the hinge 13, and the metal rotary shaft 14 for portrait-oriented opening purpose (hereinafter called a “first metal rotary shaft”), the flip cellular phone 30 of the present embodiment also has a metal rotary shaft 31 making up a second hinge for landscape-oriented opening purpose (hereinafter called a “second metal rotary shaft”).

As shown in FIGS. 7(a) and 7(b), the second metal rotary shaft 31 includes a stationary section 311 of the second metal rotary shaft fastened to the lower enclosure 11 and a rotary section 313 of the second metal rotary shaft capable of turning, in the horizontal direction with reference to a center of rotation, a joint 312 of the second metal rotary shaft making up a second joint with respect to the stationary section 311 of the second metal rotary shaft.

The stationary section 311 of the second metal rotary shaft is fastened to the hinge 13, and the rotary section 313 of the second metal rotary shaft is fastened to the upper enclosure 12. The joint 312 of the second metal rotary shaft makes up a shaft that relatively rotates the upper enclosure 12 and the lower enclosure 11 along a direction orthogonal to a rotary shaft of the first metal rotary shaft of the hinge 13. Further, there is provided the joint 312 of the second metal rotary shaft that can support, in a turanble fashion, the stationary section 311 of the second metal rotary shaft and the rotary section 313 of the second metal rotary shaft. The stationary section 311 of the second metal rotary shaft, the joint 312 of the second metal rotary shaft, and the rotary section 313 of the second metal rotary shaft are all formed from a conductive material. The stationary section 311 of the second metal rotary shaft to the rotary section 313 of the second metal rotary shaft are electrically connected.

Spacing D3 between the stationary section 311 of the second metal rotary shaft and the rotary section 142 of the first metal rotary shaft 14 is desirably; for instance, 5 mm or more.

As a result of an axial direction of the second metal rotary shaft 31 and an axial direction of the first metal rotary shaft 14 being arranged so as to intersect at right angles, electromagnetic coupling between the first metal rotary shaft 14 and the second metal rotary shaft 31 is weakened when the first metal rotary shaft 14 operates as an antenna, whereby deterioration of emission efficiency due to electromagnetic coupling can be suppressed.

As mentioned above, according to the present embodiment, the biaxial flip cellular phone has the second metal rotary shaft and can open and close in the right-left direction (the landscape direction) as well as in the up-down direction (the portrait direction). In the flip cellular phone, the axial direction of the second metal rotary shaft 31 and the axial direction of the first metal rotary shaft 14 are arranged so as to intersect at right angles, and predetermined spacing is assured. Thus, when the first metal rotary shaft 14 operates as an antenna in the cellular phone that variously changes in style, a superior emission characteristic can be assured.

### Fourth Embodiment

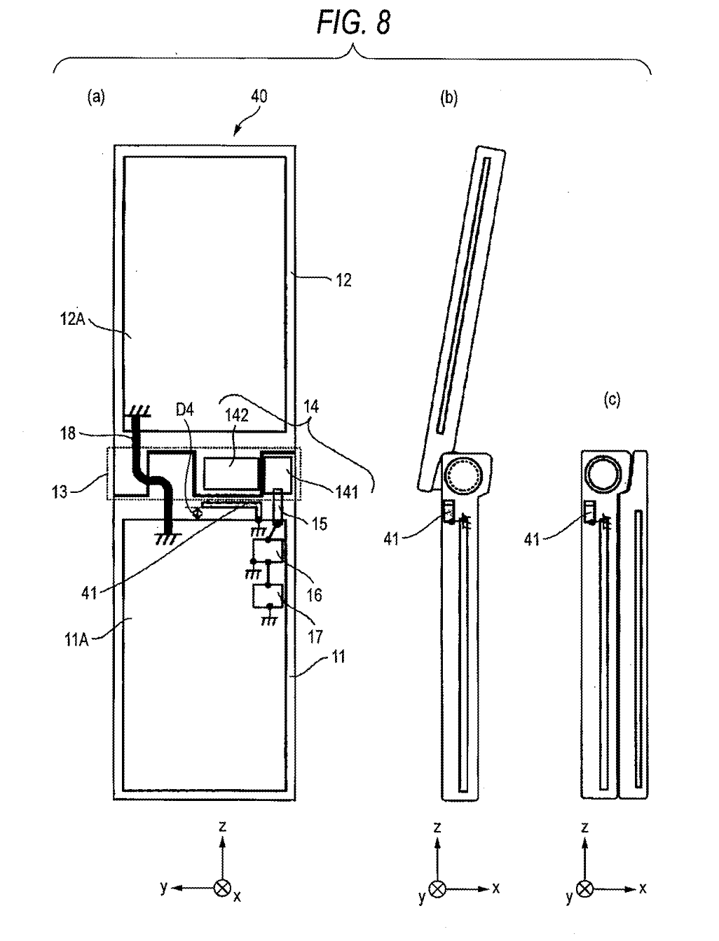

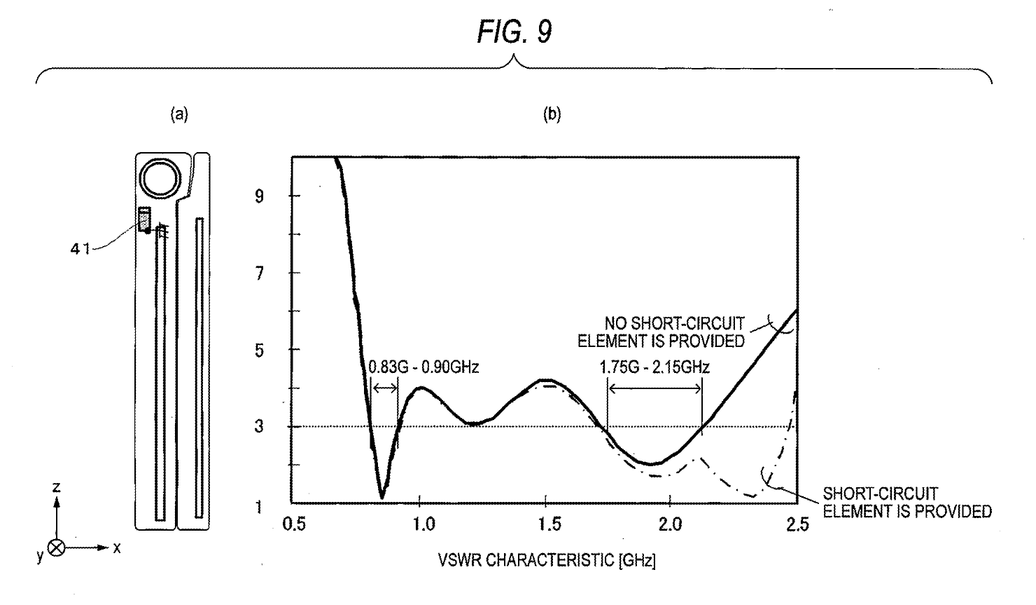

A fourth embodiment of the present invention is now described in detail by reference to FIGS. 8(a) to 8(c) and FIGS. 9(a) and 9(b). In the embodiment, elements that are identical with their counterparts described in connection with the first embodiment are assigned the same reference numerals, and their repeated explanations are omitted here.

FIG. 8(a) is a front view of a flip cellular phone 40 of the fourth embodiment of the present invention in an open state; FIG. 8(b) is a right side view of the flip cellular phone 40 of the fourth embodiment of the present invention in an open state; and FIG. 8(c) is a right side view of the flip cellular phone 40 of the fourth embodiment of the present invention in a closed state.

In the flip cellular phone 40 of the present embodiment, a short-circuit element 41 is positioned between the metal rotary shaft 14 and the first circuit board 11A substantially in parallel to the metal rotary shaft 14, and one end of the short-circuit element 41 is connected to a ground pattern laid on the first circuit board 11A in proximity to the feed spring 15. The short-circuit element 41 is kept at a predetermined distance apart from the ground pattern of the first circuit board 11A. It is desirable to hold spacing D4 of; for instance, 3 mm or more, between the short-circuit element 41 and the ground pattern of the first circuit board 11A. An element length of the short-circuit element 41 is slightly made shorter than a value of about a quarter of a wavelength λm of the maximum frequency at a desirable frequency band (the second operation frequency band f2 of the present embodiment).

Operation of the flip cellular phone 40 of the fourth embodiment of the present invention is now described by reference to FIG. 9(a) and FIG. 9(b). FIG. 9(a) is a right side view of the flip cellular phone 40 of the fourth embodiment of the present invention in a closed state, and FIG. 9(b) is a view showing a VSWR characteristic exhibited when the flip cellular phone 40 of the fourth embodiment of the present invention in the state shown in FIG. 9(a) has the short-circuit element and when the flip cellular phone does not have any short-circuit element. In general, VSWR<3 is defined as a bandwidth of the antenna. When the short-circuit element 41 is not present, VSWR<3 can be narrowly assured at 1.75 GHz band to 2.15 GHz band, which is the second frequency band. In the meantime, when the short-circuit element 41 is present, the bandwidth can be assured from 1.75 GHz band to a vicinity of about 2.4 GHz band. The reason for this is as follows. Since the length of the metal rotary shaft 14 used as an antenna is about a quarter wavelength of the second operation frequency band f2, an antenna current is found in the first circuit board 11A. The length is set such that the short-circuit element 41 resonates the antenna current at a frequency which is slightly higher than the maximum frequency of the second operation frequency band f2 at a desired frequency band, whereby a wider bandwidth is accomplished. Further, the VSWR characteristic exhibited at 2 GHz band is improved, whereby reduction of matching loss and an increase in antenna gain can be achieved.

As mentioned above, in the present embodiment, the short-circuit element 41 is laid substantially in parallel to the metal rotary shaft 14 between the metal rotary shaft 14 and the first circuit board 11A. One end of the short-circuit element 41 is connected to the ground pattern on the first circuit board 11A located in the vicinity of the feed spring 15. The element length of the short-circuit element 41 is made slightly shorter than about a quarter of the wavelength λm of the maximum frequency of the desired frequency band (the second operation frequency band f2), whereby a much broader bandwidth is accomplished, to thus enable assurance of superior communication performance.

### Fifth Embodiment

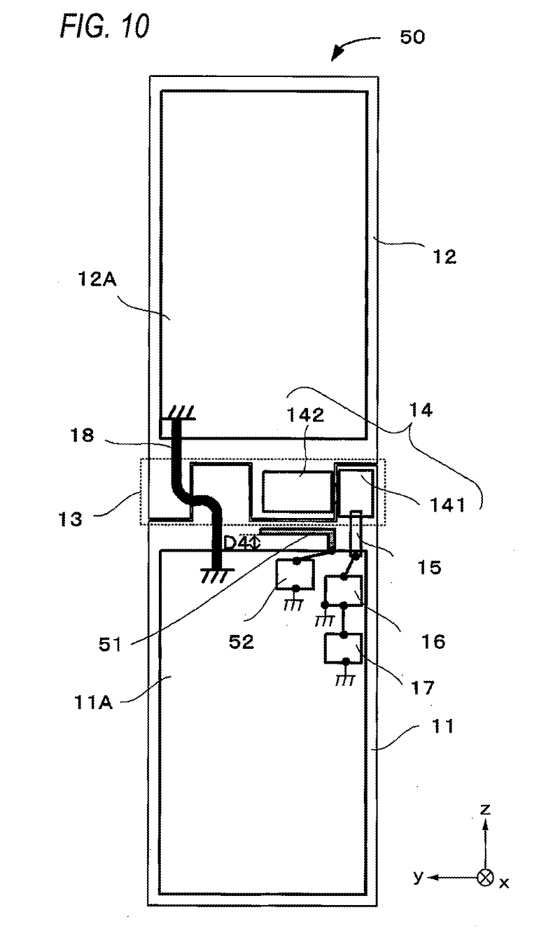

A fifth embodiment of the present invention is now described in detail by reference to FIG. 10. In the embodiment, elements that are identical with their counterparts described in connection with the first embodiment are assigned the same reference numerals, and their repeated explanations are omitted here.

FIG. 10 is a front view of a flip cellular phone 50 of the fifth embodiment of the present invention in an open state.

In the flip cellular phone 50 of the present embodiment, a short-circuit element 51 is positioned between the metal rotary shaft 14 and the first circuit board 11A substantially in parallel to the metal rotary shaft 14, and one end of the short-circuit element 51 is connected to the ground pattern laid on the first circuit board 11A in proximity to the feed spring 15 by way of a reactance element 52. The short-circuit element 51 is kept at a predetermined distance apart from the ground pattern of the first circuit board 11A. It is desirable to hold spacing D4 of; for instance, 3 mm or more, between the short-circuit element 51 and the ground pattern of the first circuit board 11A.

In order to cause a short-circuit in the short-circuit element 51 by way of the reactance element 52, the reactance element 52 is implemented by means of; for instance, an inductor. In order to accomplish performance equivalent to the performance of the short-circuit element 41 of the fourth embodiment, an element length of the short-circuit element 51 can be set so as to become shorter than the element length of the short-circuit element 41 of the fourth embodiment.

Therefore, in the present embodiment, the reactance element 52 is connected to a short-circuit end of the short-circuit element 51 and is brought into a short circuit. Thereby, when compared with the case of the short-circuit element 41 that is not equipped with the reactance element 52, the element length of the short-circuit element can be made shorter, which is effective for miniaturization of the cellular phone.

### Sixth Embodiment

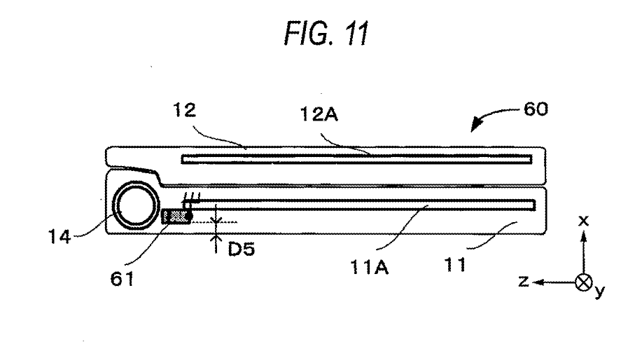

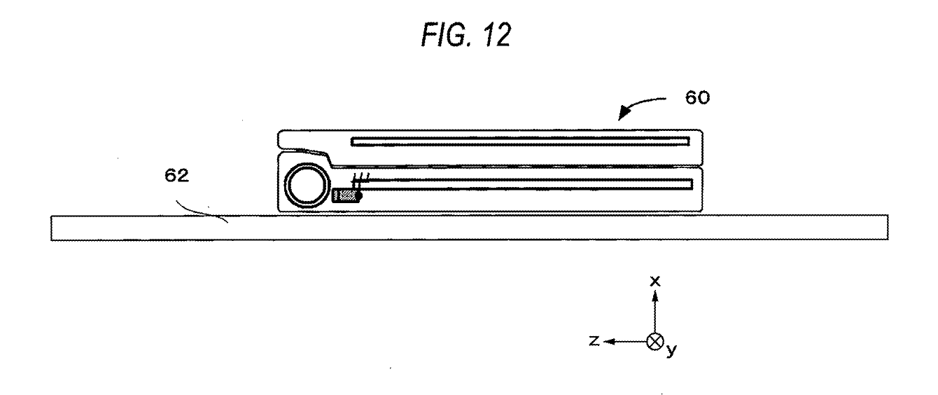

A sixth embodiment of the present invention is now described in detail by reference to FIGS. 11 and 12. In the embodiment, elements that are identical with their counterparts described in connection with the first embodiment are assigned the same reference numerals, and their repeated explanations are omitted here.

FIG. 11 is a side view of a flip cellular phone 60 of a sixth embodiment of the present invention in a closed state.

In the flip cellular phone 60 of the present embodiment, a short-circuit element 61 is positioned between the metal rotary shaft 14 and the first circuit board 11A substantially in parallel to the metal rotary shaft 14, and one end of the short-circuit element 61 is connected to the ground pattern laid on the first circuit board 11A in proximity to the feed spring 15. The short-circuit element 61 is kept at a predetermined distance apart from the ground pattern of the first circuit board 11A. The short-circuit element 61 is placed at predetermined distance from a surface of the lower enclosure 11 opposing to its key surface (not shown); namely, a surface of the lower enclosure 11 that comes into proximity to an opposing surface of the upper enclosure 12 when the cellular phone is closed.

Next, operation of the flip cellular phone 60 of the sixth embodiment of the present invention is now described by reference to FIGS. 11 and 12.

FIG. 12 is a side view of the flip cellular phone 60 of the sixth embodiment of the present invention achieved when placed on a metal desk.

The short-circuit element 61 is placed at a predetermined distance; for instance, a distance of about 2 mm, apart from a surface of the lower enclosure 11 opposing its key surface. As shown in FIG. 12, when the flip cellular phone 60 is placed on a metal desk 62; in general, when the antenna and the metal desk 62 come into extremely close proximity to each other, occurrence of a case where an antenna gain will be deteriorated under influence of electromagnetic coupling is conceivable. In order to lessen the influence of electromagnetic coupling, it is desirable to increase a distance between the metal desk 62 and the antenna. In the embodiment, since the short-circuit element 61 resonates around the maximum frequency of the second operation frequency band f2 of the antenna of the metal rotary shaft 14, the short-circuit element 61 is placed at a distance from the metal desk 62, thereby improving a gain. Therefore, when the short-circuit element 61 is provided as in the case of the present embodiment, the gain of the frequency band at which the short-circuit element 61 resonates when the cellular phone is placed on the metal desk 62 can be enhanced by about 3 dB as compared with a case where an interval is not required at the time of placement of a short-circuit element.

Therefore, in the present embodiment, the short-circuit element 61 is placed at a predetermined distance from the surface of the lower enclosure 11 opposing its key surface. As a result, even when the cellular phone is placed on the metal desk 62, high emission performance can be exhibited, and superior communication performance can be assured.

### Seventh Embodiment

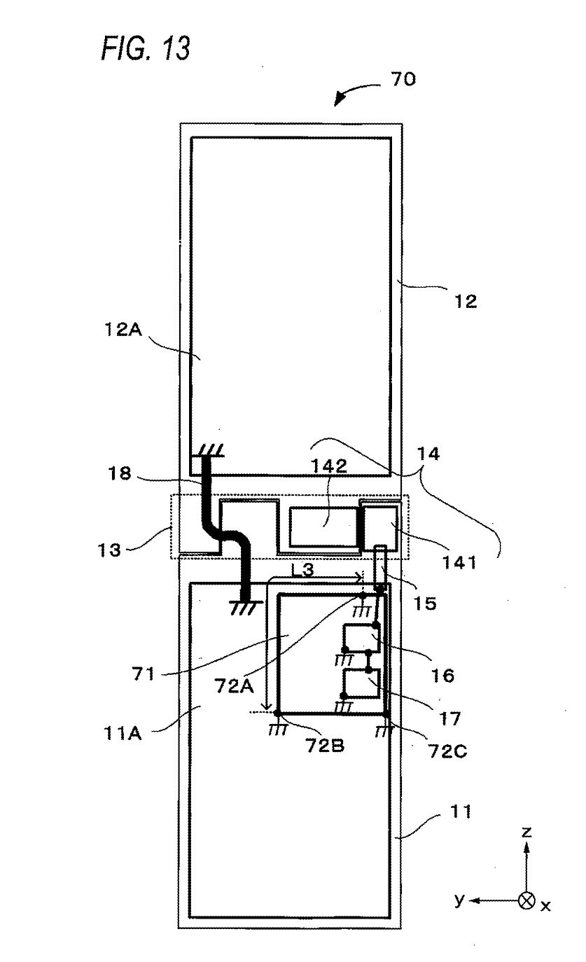

A seventh embodiment of the present invention is now described in detail by reference to FIG. 13. In the embodiment, elements that are identical with their counterparts described in connection with the first embodiment are assigned the same reference numerals, and their repeated explanations are omitted here.

FIG. 13 is a front view of a flip cellular phone 70 of a seventh embodiment of the present invention in an open state.

The flip cellular phone 70 of the present embodiment has a shield case 71 for lowering unwanted emission from the radio circuit 17 and short-circuit contact points 72A, 72B, and 72C located between the shield case 71 and the ground pattern of the first circuit board 11A. The short-circuit contact point 72A of the shield case 71 is connected to the ground pattern on the first circuit board 11A located in the vicinity of the feed spring 15. Spacing L3 among the short-circuit contact point 72A, the short-circuit contact point 72B, and the short-circuit contact point 72C is set to about one-half the wavelength λm of the maximum frequency of the desired frequency band (the second operation frequency band f2 of the present embodiment).

Operation of the present embodiment is now described by reference to FIG. 13. The shield case 71 exhibits a role of suppressing emission of a radio wave. In order to assure the effect, a plurality of ground points must be placed on the ground pattern of the first circuit board 11A.

In the present embodiment, the flip cellular phone is configured by use of the shield case 71 so as to perform broadband operation in the same manner as is performed by the short-circuit element 41 in the fourth embodiment shown in FIG. 8(a) and FIG. 8(b). Thus, an attempt is made to accomplish both a broader bandwidth and a radio shield.

When the shield case 71 is utilized as the short-circuit element 41, the short-circuit contact point 72A between the shield case 71 and the ground pattern on the first circuit board 11A is connected to a point on the ground pattern, in the vicinity of the feed spring 15, on the first circuit board 11A. The other short-circuit contact points 72B and 72C are placed at points where a current distribution achieved at the maximum frequency of a desired band becomes maximum; namely, at a distance of about one-half the wavelength λm of the maximum frequency of the desired band from the short-circuit contact point 72A. As a result of the short-circuit contact points being placed as mentioned above, a broader bandwidth can be accomplished in substantially the same manner as is accomplished by the short-circuit element 41 of the fourth embodiment.

Thus, both a broader bandwidth of the antenna and the radio shield can be accomplished.

As mentioned above, according to the present embodiment, the short-circuit contact point 72A between the shield case 71 and the ground pattern on the first circuit board 11A is connected to a point on the ground pattern, in the vicinity of the feed spring 15, on the first circuit board 11A. The other short-circuit contact points 72B and 72C are placed at a distance of about one-half the wavelength λm of the maximum frequency of the desired band from the short-circuit point 72A. As a result, a broader bandwidth is accomplished, and the shield can be also utilized as a radio shield. Therefore, a necessity for another element to be used as a short-circuit element becomes obviated, so that miniaturization and cost reduction of the cellular phone can be fulfilled.

Although the present invention has been described in detail and by reference to the specific embodiments, it is manifest to those skilled in the art that the present invention is susceptible to various alterations or modifications without departing the spirit and scope of the present invention.

The present patent application is based on Japanese Patent Application (JP-2009-144904) filed on Jun. 18, 2009, the entire subject matter of which is incorporated herein by reference.

### INDUSTRIAL APPLICABILITY

The portable wireless device of the present invention simultaneously enables a reduction in thickness and size of an enclosure, also yields an advantage of the ability to exhibit high communication performance, and is useful for; for instance, a flip cellular phone.

### DESCRIPTIONS OF THE REFERENCE NUMERALS AND SYMBOLS

10, 20, 30, 40, 50, 60, 70 FLIP CELLULAR PHONE
11 CELLULAR PHONE
11A FIRST CIRCUIT BOARD (LOWER CIRCUIT BOARD)
12 UPPER ENCLOSURE (SECOND ENCLOSURE)
12A SECOND CIRCUIT BOARD (UPPER CIRCUIT BOARD)
13 HINGE
14 METAL ROTARY SHAFT (FIRST METAL ROTARY SHAFT)
140 JOINT
141 STATIONARY SECTION OF METAL ROTARY SHAFT
142 ROTARY SECTION OF METAL ROTARY SHAFT
15 FEED SPRING
16 IMPEDANCE MATCHING CIRCUIT
17 RADIO CIRCUIT
21 THIRD CIRCUIT BOARD
22, 52 REACTANCE ELEMENT
31 SECOND METAL ROTARY SHAFT
311 STATIONARY SECTION OF SECOND METAL ROTARY SHAFT
312 JOINT OF SECOND METAL ROTARY SHAFT
313 ROTARY SECTION OF SECOND METAL ROTARY SHAFT
41, 51, 61 SHORT-CIRCUIT ELEMENT
62 METAL DESK
71 SHIELD CASE
72A, 72B, 72C SHORT-CIRCUIT CONTACT POINT

1. An antenna, comprising:
a first housing provided with a first circuit board;
a second housing provided with a second circuit board;
a first metal rotary shaft that joins the first housing to the second housing in a rotatable manner and that exhibits electrical conductivity;
a feed section connected to the first metal rotary shaft;
a matching circuit placed on the first circuit board and connected to the feed section; and
a radio circuit connected to the matching circuit and placed on the first circuit board,
wherein the first metal rotary shaft is placed at a given interval away from a ground pattern on the first circuit board and electrically connected to the feed section;
the first metal rotary shaft operates as an antenna at a first frequency band and a second frequency band that is higher than the first frequency band;
a diameter of a cross section of the first metal rotary shaft is set to about 1/20 of a wavelength corresponding to the second frequency band; and
the first metal rotary shaft does not oppose a ground pattern on the second circuit board along a thicknesswise direction of the housings when the first and second housings are closed.

2. The antenna according to claim 1, wherein, when the first housing and the second housing are closed, an axial center of the first metal rotary shaft is situated on the first housing.

3. The antenna according to claim 1, further comprising:
a third circuit board placed in the second housing in proximity to the first metal rotary shaft;
wherein the second circuit board and the third circuit board are connected together by a reactance element; and
a ground pattern on the third circuit board opposes the first metal rotary shaft in a thicknesswise direction of the housings when the first housing and the second housing are closed.

4. The antenna according to claim 1, further comprising:
a second metal rotary shaft that exhibits electrical conductivity and that joins the first housing to the second housing in a rotatable manner along an axial direction orthogonal to an axial direction of the first metal rotary shaft,
wherein the first metal rotary shaft and the second metal rotary shaft are at a given interval away from each other.

5. The antenna according to claim 1, further comprising a short-circuit element that is away at a given interval from the first metal rotary shaft and the first circuit board and that is laid substantially in parallel with the first metal rotary shaft,
wherein one end of the short-circuit element is short-circuited to the ground pattern on the first circuit board located in proximity to the feed section.

6. The antenna according to claim 5, wherein one end of the short-circuit element is short-circuited to the ground pattern on the first circuit board located in proximity to the feed section by way of a reactance element.

7. The antenna according to claim 5, wherein the short-circuit element is at a given interval away from a surface of the first housing that opposes another surface thereof which comes into close proximity to a surface of the second housing when the first housing and the second housing are closed.

8. The antenna according to claim 1, further comprising:
a metal shield that blocks unwanted emission of the radio circuit, wherein a first short-circuit point of the metal shield is short-circuited to the ground pattern on the first circuit board located in proximity to the feed section; and
a second short-circuit point is placed away from the first short-circuit point at an interval that is about one-half a wavelength corresponding to a high frequency band and is short-circuited to the ground pattern on the first circuit board.

9. A portable wireless terminal provided with the antenna according to claim 1.
